(19) United States
(12) Patent Application Publication
(10) Pub. No.: US 2015/0096044 A1
(43) Pub. Date: Apr. 2, 2015

(54) Method and device for adjusting screen locking time, and electronic terminal

(71) Applicants: Yong Zhou, Shenzhen (CN); Feng Yu, Shenzhen (CN); Hua Chen, Shenzhen (CN); Hongbo Li, Shenzhen (CN)

(72) Inventors: Yong Zhou, Shenzhen (CN); Feng Yu, Shenzhen (CN); Hua Chen, Shenzhen (CN); Hongbo Li, Shenzhen (CN)

(73) Assignee: ZTE CORPORATION, Shenzhen, Guangdong (CN)

(21) Appl. No.: 14/385,963

(22) PCT Filed: Apr. 27, 2012
(86) PCT No.: PCT/CN2012/074857

§ 371 Date: Oct. 13, 2014

(30) Foreign Application Priority Data
Mar. 21, 2012 (CN) 201210075659.4

(51) Int. Cl. G06F 21/62

(52) U.S. Cl. CPC G06F 21/6218
USPC 726/26

(57) ABSTRACT

Disclosed are a method and a device for adjusting screen locking time, and an electronic terminal. Time interval values T1, T2, . . . , and TN between screen locking and screen unlocking for consecutive N times are acquired, and when it is determined that the acquired time interval values T1, T2, . . . , and TN are all in a preset threshold range, a current screen locking time value is updated into the sum of the current screen locking time value and a preset time delay value. In the disclosure, a usage situation in which the terminal automatically locks the screen and a user unlocks the screen is monitored in real time, and according to the time intervals between screen locking and screen unlocking for consecutive N times, it is determined whether the current screen locking time is appropriate in the current usage environment and situation. When the determining result is that the current screen locking time is inappropriate, the current screen locking time value is automatically updated into the current screen locking time value plus the preset time delay value, so as to achieve the objective of dynamically adjusting the screen locking time according to the current usage environment and situation, thereby effectively reducing the unlocking operations and screen locking settings of the user and improving satisfaction in the user experience.

### FIELD

The disclosure relates to the field of mobile terminals, and more particularly to a method and a device for adjusting screen locking time, and an electronic terminal.

### BACKGROUND

At present, most mobile terminals in people's daily life generally support automatic screen locking in order to avoid misoperation and protect privacy, i.e. if a user does not operate initiatively within a period of time, a terminal will lock the screen automatically. The delay time from the moment when a user stops operation to the moment before a screen is locked automatically is commonly known as automatic screen locking time, or screen locking time for short. Generally, a terminal will provide a group of screen locking time for a user to select, e.g. 10 seconds, 20 seconds, 30 seconds, 1 minute etc. Once set, the screen locking time of an existing mobile terminal is fixed unless being modified by a user initiatively. If a user does not set the screen locking time, a system will generally apply a default value. Since different users have different usage habits, the fixed screen locking time cannot be completely applicable to each user, or even if the fixed screen locking time is applicable to some usage scenarios of users, it is not applicable to some other usage scenarios, e.g. although a relatively short period of screen locking time may be set to prevent misoperation of a terminal effectively, unlocking operations may be added for a user, which causes trouble to the user; moreover, although a relatively long period of screen locking time may reduce unlocking operations for a user, the possibility of misoperation may be increased. Of course, a user may also switch different screen locking time manually according to different usage scenarios, but frequent manual switching is a burden itself for the user. Therefore, it is in urgent need of a method for automatically adjusting the screen locking time of the terminal according to usage scenarios and habits of users so as to improve the satisfaction in user experience.

### SUMMARY

In view of this, the disclosure provides a method and a device for adjusting screen locking time, and an electronic terminal capable of automatically adjusting the screen locking time of a terminal dynamically according to different usage scenarios and habits to further improve the satisfaction in user experience.

To solve the technical problem above, the disclosure provides a method for adjusting screen locking time, including:

acquire time interval values T1, T2, . . . , and TN between screen locking and screen unlocking for consecutive N times, wherein the N value is a preset value;

determine whether the acquired time interval values T1, T2, . . . , and TN are all in a preset threshold range; and

when it is determined that the acquired time interval values T1, T2, . . . , and TN are all within the preset threshold range, updating a current screen locking time value into the sum of the current screen locking time value and a preset time delay value.

In an embodiment of the disclosure, when acquiring the time interval values between screen locking and screen unlocking for N times, the method further may include: acquiring time interval values T21, T22, . . . , and T2N between the last time when a user operates initiatively and the current unlocking moment after each unlocking and before the next screen locking;

according to the time interval values T21, T22, . . . , and T2N, acquire a first time delay value according to a first preset rule, wherein the preset delay value may include the first time delay value.

In an embodiment of the disclosure, after acquiring the time interval values T1, T2, . . . , and TN between screen locking and screen unlocking for consecutive N times, the method further may include:

according to the time interval values T1, T2, . . . , and TN, acquire a second time delay value according to a second preset rule; the preset time delay value may include the second time delay value.

In an embodiment of the disclosure, when acquiring the time interval values between screen locking and screen unlocking for N times, the method further may include:

acquire time values T31, T32, . . . , T3N consumed by each unlocking; according to the time values T31, T32, . . . , T3N, acquire a third time delay value according to a third preset rule, wherein the preset time delay value includes the third time delay value.

In an embodiment of the disclosure, the preset time delay value may include a fourth time delay value; the fourth time delay value is a preset time delay compensation value.

In an embodiment of the disclosure, updating the current screen locking time value into the sum of the current screen locking time value and the preset time delay value may include:

updating a current default screen locking time value into the sum of a current default screen locking time value and the preset time delay value.

In an embodiment of the disclosure, after updating the current default screen locking time value into the sum of the current default screen locking time value and the preset time delay value, the method further may include:

determining whether the user locks the screen initiatively after the last unlocking or if the user has not operated within a preset operation time threshold; if the screen is locked initiatively or the user has not operated within the preset operation time threshold, recovering a screen locking time value into the default screen locking time value.

In an embodiment of the disclosure, after updating the current screen locking time value into the sum of the current screen locking time value and the preset time delay value, the method further may include:

storing the updated screen locking time value, and record steps of a current usage scenario; associating the current usage scenario with the updated screen locking time value; when it is detected that a terminal enters the usage scenario, updating the current screen locking time value into the updated screen locking time value directly.

The disclosure further provides a device for adjusting screen locking time, including a time value acquiring module, a determining module and a processing module, wherein

the time value acquiring module is configured to acquire time interval values T1, T2, . . . , and TN between screen locking and screen unlocking for consecutive N times, and send the acquired time interval values T1, T2, . . . , and TN to the determining module, wherein the N value is a preset value;

the determining module is configured to determine whether the acquired time interval values T1, T2, . . . , and TN are all within a preset threshold range and send a determining result to the processing module;

the processing module is configured to receive the determining result, and when the determining result indicates that the acquired time interval values T1, T2, . . . , and TN are all within the preset threshold range, update a current screen locking time value into the sum of the current screen locking time value and a preset time delay value.

In an embodiment of the disclosure, the time value acquiring module is further configured to, when acquiring the time interval values between the screen locking and unlocking for N times, acquire time interval values T21, T22, . . . , and T2N between the last time when a user operates initiatively and the current unlocking moment after each unlocking and before the next screen locking; and according to the time interval values T21, T22, . . . , and T2N, acquire a first time delay value according to a first preset rule, wherein the preset delay value may include the first time delay value.

In an embodiment of the disclosure, the time value acquiring module is further configured to, after acquiring the time interval values T1, T2, . . . , and TN between screen locking and screen unlocking for consecutive N times, acquire according to the time interval values T1, T2, . . . , and TN a second time delay value according to a second preset rule, wherein the preset time delay value may include the second time delay value.

In an embodiment of the disclosure, the time value acquiring module is further configured to, when acquiring the time interval value between the screen locking and unlocking for N times, acquire time values T31, T32, . . . , T3N consumed by each unlocking; according to the time values T31, T32, . . . , T3N, acquire a third time delay value according to a third preset rule, wherein the preset time delay value may include the third time delay value.

In an embodiment of the disclosure, the device further may include a monitoring module;

the processing module is configured to update a current default screen locking time value into the sum of a current default screen locking time value and the preset time delay value;

the monitoring module is configured to determine whether the user locks the screen initiatively after the last unlocking or if the user has not operated within a preset operation time threshold; when the screen is locked initiatively or the user has not operated within the preset operation time threshold, notify the processing module to recover a screen locking time value into the default screen locking time value.

In an embodiment of the disclosure, the device further may include an associating module;

the processing module is further configured to store the updated screen locking time value;

the associating module is configured to record steps of a current usage scenario, associate the current usage scenario with the updated screen locking time value; when it is detected that a terminal enters the usage scenario, notify the processing module to update the current screen locking time value into the updated screen locking time value directly.

The disclosure further provides an electronic terminal, including a display screen, wherein it further may include the above device for adjusting screen locking time; the device for adjusting screen locking time is connected with the display screen and configured to adjust the screen locking time of the electronic terminal.

The disclosure has the following beneficial effect: according to a method for adjusting screen locking time of the disclosure, time interval values T1, T2, . . . , and TN between screen locking and screen unlocking for consecutive N times are acquired, and when it is determined that the acquired time interval values T1, T2, . . . , and TN are all within a preset threshold range, a current screen locking time value is updated into the sum of the current screen locking time value and a preset time delay value. In the disclosure, a usage situation in which a terminal automatically locks the screen and a user unlocks the screen is monitored in real time, and according to the time intervals between screen locking and screen unlocking for consecutive N times, it is determined whether the current screen locking time is appropriate in the current usage environment and situation. When the determining result is that the current screen locking time is inappropriate, the current screen locking time value is automatically updated into the current screen locking time value plus the preset time delay value, so as to dynamically adjust the screen locking time according to the current usage environment and situation. The user does not need to unlock frequently and does not need to switch the screen locking time manually in different usage environments, thereby effectively reducing the unlocking operations and screen locking settings of the user and improving satisfaction in the user experience.

### BRIEF DESCRIPTION OF THE DRAWINGS

FIG. 1 is a flowchart of an embodiment of a method for adjusting screen locking time of the disclosure;

FIG. 2 is a flowchart of another embodiment of a method for adjusting screen locking time of the disclosure;

FIG. 3 is a structural diagram of an embodiment of a device for adjusting screen locking time of the disclosure;

FIG. 4 is a structural diagram of another embodiment of a device for adjusting screen locking time of the disclosure; and

FIG. 5 is a structural diagram of still another embodiment of a device for adjusting screen locking time of the disclosure.

### DETAILED DESCRIPTION

The disclosure will be further described in details below through embodiments and in combination with the accompanying drawings.

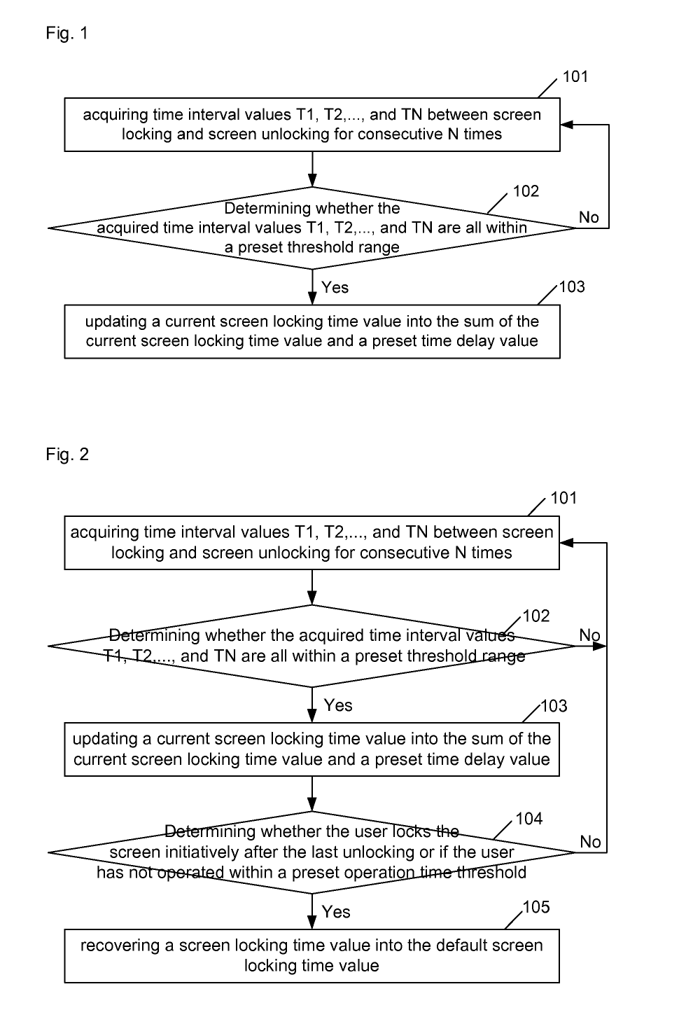

A method for adjusting screen locking time in the present embodiment is applicable to a mobile terminal and other terminals that needs a screen locking operation, e.g. electronic mobile terminals including a mobile phone, a laptop, and iPad etc., and is also applicable to a common desktop computer etc. Referring to FIG. 1, the method mainly includes the following steps.

Step 101: Time interval values T1, T2, . . . , and TN between screen locking and screen unlocking for consecutive N times are acquired,

wherein the N value is a preset value and a specific value thereof may be selected and set according to actual conditions, e.g. the N value may be selected and set according to different usage scenarios and usage conditions, specifically the N value may be 2 or 3, which can improve the timeliness of adjustment of screen locking time; the time interval values between screen locking and screen unlocking are acquired for many times so that the unlocking and usage habits of a user in different usage environments and situations can be analyzed according to the time interval values to find a rule of unlocking operations of the user, intelligently adjust the automatic screen locking time of a mobile terminal and effectively reduce unlocking operations of the user.

Step 102: Whether the acquired time interval values T1, T2, . . . , and TN are all within a preset threshold range is determined, i.e. whether the user performs unlocking immediately or within a relatively short period of time after each screen locking is determined; if yes, it is determined that a screen locking time value set currently fails to meet a current requirement of the user and the screen locking time needs to be prolonged, then Step 103 is performed; however, if the user performs unlocking within a relatively long period of time after screen locking, it is indicated that the screen locking time value set currently basically meets a current usage requirement of the user, then Step 101 is performed; therefore, the preset threshold range in the present embodiment may be selected and set according to actual conditions, and may be specifically selected and set according to different requirements or different usage scenarios of the user, e.g. the threshold range may be set as 0 to 5 seconds.

Step 103: When it is determined that the time interval values T1, T2, . . . , and TN are all within the preset threshold range, it is indicated that the screen locking time value set currently is inappropriate to the user, and a current screen locking time value is updated into the sum of the current screen locking time value and a preset time delay value.

Therefore, the adjusting method in the present embodiment can monitor a usage situation in which a terminal automatically locks the screen and a user unlocks the screen in real time, and according to the time intervals between screen locking and screen unlocking for consecutive N times, it is determined whether the current screen locking time is appropriate in the current usage environment and situation; when it is inappropriate, the current screen locking time value is automatically updated into the current screen locking time value plus the preset time delay value, so as to f dynamically adjust the screen locking time according to the current usage environment and situation; the user does not need to unlock frequently and does not need to switch the screen locking time manually in different usage environments, thereby effectively reducing the unlocking operations and screen locking settings of the user and improving satisfaction in the user experience;

It should be noted that, when the current screen locking time value is updated into the sum of the current screen locking time value and the preset time delay value in the present embodiment, there may be many methods for setting and selecting the preset time delay value, e.g. one or more fixed time values may be selected as the time delay value according to specific statistical usage conditions of the user, e.g. 10 seconds or 20 seconds may be selected fixedly as the preset time delay value; when it is detected, according to the method above, that the current screen locking time value cannot meet the requirement of the user, the current screen locking time value is updated into the current screen locking time value plus the preset time delay value of 10 seconds or 20 seconds.

Besides the methods above, the preset time delay value may be also specifically determined according to a current usage scenario of the user, e.g. when browsing a webpage, if the user browses one page within 20 seconds while the screen locking time value set currently is 10 seconds, then the user needs to perform an unlocking operation accordingly after browsing each page, i.e. an unlocking operation needs to be performed every 10 seconds; accordingly, when the user switches to another usage scenario, a switching operation might be performed initiatively every 30 seconds while the current screen locking time is 10 seconds, then the user needs to perform unlocking twice before the user operates initiatively. It can be learned that the user operates initiatively at different time intervals in different usage scenarios for tasks executed by the terminal currently (e.g. webpage browsing, novel reading), thus in order to better meet user requirements, the preset time delay value may be specifically selected and determined according to a current usage scenario of the user; moreover, it can be learned from the analysis above that the time interval values between the last time when the user operates initiatively and the current unlocking moment after each unlocking and before the next screen locking are important basis for setting the preset time delay value; more specifically, when acquiring the time interval values for N times between screen locking and screen unlocking, the following steps are further included: acquiring time interval values T21, T22, . . . , and T2N between the last time when the user operates initiatively and the current unlocking moment after each unlocking and before the next screen locking; and according to the time interval values T21, T22, . . . , and T2N, acquiring a first time delay value according to a first preset rule, wherein the preset delay value includes the first time delay value, i.e. when the current screen locking time value is updated, it is updated into a value which includes the first time delay value. The first preset rule may be selecting a maximum time value MAX[T21, T22, T2N] from the time interval values T21, T22, . . . , and T2N, or may be randomly selecting a time value from the time interval values T21, T22, . . . , and T2N, or taking the average value of the time interval values T21, T22, . . . , and T2N etc., as long as the selected time value basically meets the user requirements. To best meet operation requirements of the user, the maximum time value MAX [T21, T22, . . . , T2N] is preferably selected from the time interval values T21, T22, . . . , and T2N in the present embodiment as the first time delay value.

In other embodiments of the disclosure, in order to adjust the screen locking time value more precisely, the time interval values between each screen locking and unlocking may be further used as one of the bases for setting the preset time delay value to learn the usage habits and rules of the user more precisely; therefore, after acquiring the time interval values T1, T2, . . . , and TN in the step above, a second time delay value may be further acquired according to the time interval values T1, T2, . . . , and TN and a preset second preset rule; the preset time delay value may include the first time delay value and the second time delay value; the second preset rule may be the same as the first preset rule; in the present embodiment, the maximum time value MAX[T1, T2, TN] in the time interval values T1, T2, . . . , and TN may be also used preferably as the second time delay value.

In other embodiments of the disclosure, in order to adjust the screen locking time value more precisely, a time value consumed by the user during each unlocking may be used as one of the bases for setting the preset time delay value. Therefore, when acquiring the time interval values of N times between screen locking and unlocking in the step above, the following steps may be further included: acquiring time values T31, T32, . . . , T3N consumed by each unlocking; according to the time values T31, T32, . . . , T3N, acquiring a third time delay value according to a third preset rule, wherein the preset time delay value includes the third time delay value; the third preset rule may be the same as the first preset rule. In the present embodiment, the maximum time value MAX [T31, T32, T3N] in T31, T32, . . . , T3N is also used preferably as the third time delay value, i.e. the preset time delay value may include the first time delay value and/or the second time delay value.

In addition, considering factors including uncertainty of operating time etc., the preset time delay value may further include a fourth time delay value in the present embodiment; the fourth time delay value is a preset time delay compensation value to compensate a time difference caused by other uncertain factors to best meet the operation requirements of the user.

It should be noted that updating the current screen locking time value into the sum of the current screen locking time value and the preset time delay value in the present embodiment may specifically include updating a current default screen locking time value of the terminal into the sum of a current default screen locking time value and the preset time delay value, or may also include updating the updated screen locking time value into the updated screen locking time value plus the preset time delay value over again based on the last updating. In the present embodiment, the current default screen locking time value is preferably updated into the current default screen locking time value plus the preset time delay value. Referring to FIG. 2, Step 101 to Step 103 are as described above and will not be repeated. In the present embodiment, after updating the current default screen locking time value into the sum of the current default screen locking time value and the preset time delay value, the method may further include:

Step 104: whether the user locks the screen initiatively after the last unlocking or if the user has not operated within a preset operation time threshold is determined; if yes, it is indicated that the current operation has been finished and Step 105 is then performed; otherwise, Step 101 is then performed;

Step 105: if the screen is locked initiatively or the user has not operated within the preset operation time threshold, a screen locking time value is recovered into the default screen locking time value.

At the same time, in order to avoid repeating the screen locking time adjusting process when the user switches, after finishing the current usage scenario, to the usage environment over again, the following steps may be further included: after updating the current screen locking time value into the sum of the current screen locking time value and the preset time delay value through the method above, steps of a current usage scenario are recorded; then the current usage scenario is associated with the updated screen locking time value. During a subsequent usage process, once it is detected that the user enters the usage scenario over again, the current screen locking time value may be adjusted into the updated screen locking time value directly, thus resources are saved and the satisfaction in user experience is improved.

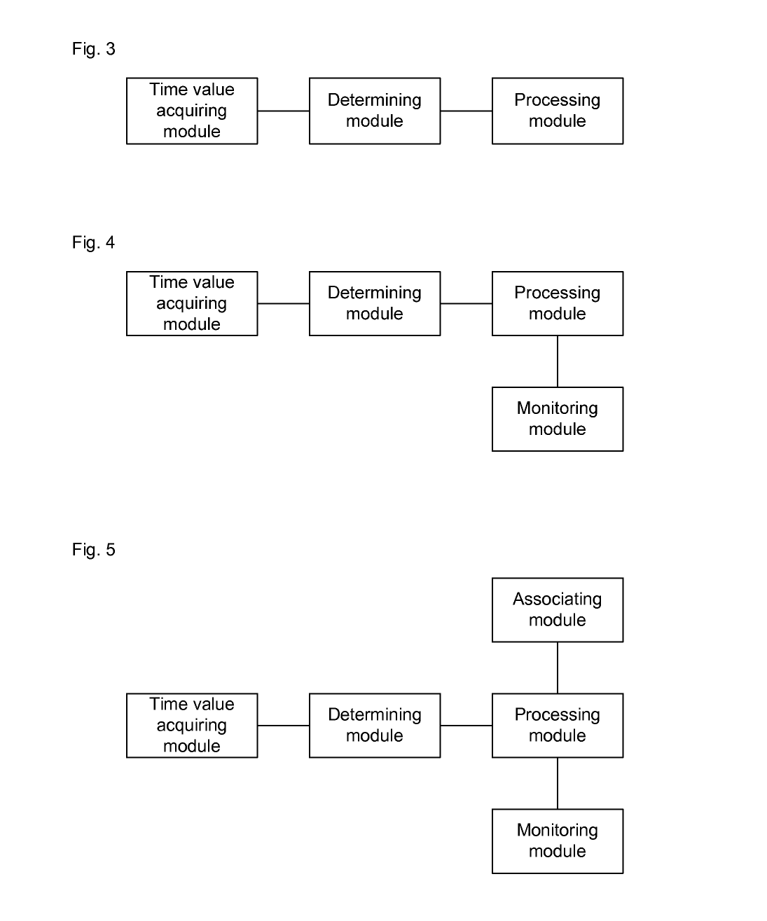

An embodiment of the disclosure further provides a device for adjusting screen locking time. The device may be provided in a terminal provided with a display screen, and connected with the display screen directly or indirectly through other paths to dynamically adjusting a screen locking time value of the terminal. Referring to FIG. 3, the device includes a time value acquiring module, a determining module and a processing module;

the time value acquiring module is configured to acquire time interval values T1, T2, . . . , and TN between screen locking and screen unlocking for consecutive N times, and send the acquired time interval values T1, T2, . . . , and TN to the determining module, wherein the N value is a preset value;

the determining module is configured to determine whether the acquired time interval values T1, T2, . . . , and TN are all within a preset threshold range and send a determining result to the processing module; and

the processing module is configured to receive the determining result, and when the determining result is yes, update a current screen locking time value into the sum of the current screen locking time value and a preset time delay value.

The time value acquiring module of the device in the present embodiment is further configured to, when acquiring the time interval values between screen locking and unlocking for N times, acquire time interval values T21, T22, . . . , and T2N between the last time when a user operates initiatively and the current unlocking moment after each unlocking and before the next screen locking; and according to the time interval values T21, T22, . . . , and T2N, acquire a first time delay value according to a first preset rule; wherein the preset delay value includes the first time delay value.

In other embodiments of the disclosure, the time value acquiring module is further configured to, after acquiring the time interval values T1, T2, . . . , and TN between screen locking and unlocking for consecutive N times, acquire according to the time interval values T1, T2, . . . , and TN a second time delay value according to a second preset rule; the preset time delay value may further include the second time delay value.

In other embodiments of the disclosure, the time value acquiring module is further configured to, when acquiring the time interval values of N times between screen locking and unlocking, acquire time values T31, T32, . . . , T3N consumed by each unlocking; according to the time values T31, T32, . . . , T3N, acquire a third time delay value according to a third preset rule; wherein the preset time delay value includes the third time delay value.

Referring to FIG. 4, the device in the present embodiment further may include a monitoring module. Updating the current screen locking time value into the current screen locking time value plus the preset time delay value by the processing module may specifically include updating a current default screen locking time value into the sum of a current default screen locking time value and the preset time delay value. The monitoring module is configured to determine whether the user locks the screen initiatively after the last unlocking or if the user has not operated within a preset operation time threshold; if yes, notify the processing module to recover a screen locking time value into the default screen locking time value.

Referring to FIG. 5, the device in the present embodiment may further include an associating module; the processing module is further configured to store the updated screen locking time value; the associating module is configured to, after the processing module updates the current screen locking time value into the current screen locking time value plus the preset time delay value, record a current usage scenario, associate the current usage scenario with the updated screen locking time value. During a subsequent usage process, once it is detected that the user enters the usage scenario over again, the processing module may be notified directly to update the current screen locking time value into the updated screen locking time value to save resources and improve the satisfaction in user experience.

To better understand the disclosure, the disclosure will be further described below in combination with a specific usage scenario. In addition, a preset time delay value in the example includes the first time delay value, the second time delay value, the third time delay value and the fourth time delay value above, and the fourth time delay value is set as 2 seconds. The specific usage scenario is as follows:

provided that a current usage scenario of a user is reading a novel, and the user finishes reading one page of the novel in about 30 seconds normally and a screen locking time value of an automatic screen locking function set by a terminal currently is 20 seconds (i.e. T=20 seconds); ideally, if the terminal does not lock the screen automatically, the user will turn a page initiatively about 30 seconds later; however, if there is automatic screen locking, the user will need to unlock the screen after reading for 20 seconds, i.e. unlocking needs to be performed every 20 seconds; an unlocking operation of the user is generally very fast, and it is assumed that the maximum value is 0.5 second, that is a maximum time value consumed by each unlocking is 0.5 second, i.e. MAX[T31, T32, . . . , T3N]=0.5; after unlocking, it will further take approximately 10 seconds for the user to finish reading; subsequently, the user will turn the page initiatively; before turning the page, the user may also have some other operations, thus the maximum time interval from each finishing moment of unlocking to the moment of last initiative operation of the user before the next screen locking is selected as 10 seconds in the disclosure, i.e. MAX [T21, T22, . . . , T2N]=10 seconds;

(1) if the user performs unlocking immediately after locking the screen, the time interval between each screen locking and unlocking may be ignored, i.e. MAX[T1, T2, . . . , TN]=0 second; at the moment, the updated screen locking time value T′ is:

T′=T+MAX[T1,T2, . . . ,TN]+MAX[T31,T32, . . . ,T3N]+MAX[T21,T22, . . . ,T2N]+the fourth time delay value=20+0+0.5+10+2=32.5 seconds;

(2) if the user performs unlocking approximately 4 seconds after locking the screen, i.e. the maximum time interval value between each screen locking and unlocking is 4 seconds, i.e. MAX[T1, T2, . . . , TN]=4 seconds, then it can be calculated that a new screen locking time value T′ is:

T′=T+MAX[T1,T2, . . . ,TN]+MAX[T31,T32, . . . ,T3N]+MAX[T21,T22, . . . ,T2N]+the fourth time delay value=20+4+0.5+10+2=36.5 seconds.

Therefore, no matter whether the user performs unlocking immediately or several seconds after locking the screen, page turning performed by the user after reading one page of the novel will not be interfered by screen locking after a user usage rule is learned through the screen locking time adjusting method provided by the disclosure to automatically adjust the screen locking time of the terminal. In addition, after updating the screen locking time value, the updated screen locking time value may be further associated with the usage scenario (e.g. novel reading). When the usage environment of reading a novel is used again, the updated screen locking time value may be invoked directly, and it is unnecessary to repeat the above adjusting process, which can further improve the satisfaction in user experience.

The above contents are further detailed descriptions of the disclosure with reference to the embodiments, and the embodiments of the disclosure cannot be thought to be limited to these descriptions. For those of ordinary skill in the field to which the disclosure belongs, some simple deduction or replacement can further be made under the premise of not departing from the conception of the disclosure, and should all be regarded as falling within the protection scope of the disclosure.

What is claimed is:

1. A method for adjusting screen locking time, comprises:
acquiring time interval values T1, T2, . . . , and TN between screen locking and screen unlocking for consecutive N times, wherein an N value is a preset value;
determining whether the time interval values T1, T2, . . . , and TN are all within a preset threshold range; and
when it is determined that the time interval values T1, T2, . . . , and TN are all within the preset threshold range, updating a current screen locking time value into a sum of the current screen locking time value and a preset time delay value.

2. The method for adjusting screen locking time according to claim 1, further comprising:
Acquiring, after each unlocking and before next screen locking, time interval values T21, T22, . . . , and T2N between last time when a user operates initiatively and a current unlocking moment; and
according to the time interval values T21, T22, . . . , and T2N, acquiring a first time delay value according to a first preset rule, wherein the preset delay value comprises the first time delay value.

3. The method for adjusting screen locking time according to claim 2, further comprising: after acquiring the time interval values T1, T2, . . . , and TN between screen locking and screen unlocking for consecutive N times,
according to the time interval values T1, T2, . . . , and TN, acquiring a second time delay value according to a second preset rule, wherein the preset time delay value comprises the second time delay value.

4. The method for adjusting screen locking time according to claim 2, further comprises:
acquiring time values T31, T32, . . . , T3N consumed by each unlocking; and
according to the time values T31, T32, . . . , T3N, acquiring a third time delay value according to a third preset rule, wherein the preset time delay value comprises the third time delay value.

5. The method for adjusting screen locking time according to claim 1, wherein the preset time delay value comprises a fourth time delay value, and the fourth time delay value is a preset time delay compensation value.

6. The method for adjusting screen locking time according to claim 1, wherein updating the current screen locking time value into the sum of the current screen locking time value and the preset time delay value comprises:
updating a current default screen locking time value into a sum of a current default screen locking time value and the preset time delay value.

7. The method for adjusting screen locking time according to claim 6, further comprising: after updating the current default screen locking time value into the sum of the current default screen locking time value and the preset time delay value,
determining whether a user performs screen locking initiatively after last unlocking or if the user has not operated within a preset operation time threshold; and
if the screen locking is performed initiatively or the user has not operated within the preset operation time threshold, recovering a screen locking time value into the default screen locking time value.

8. The method for adjusting screen locking time according to claim 1, further comprising: after updating the current screen locking time value into the sum of the current screen locking time value and the preset time delay value,
storing an updated screen locking time value, and recording steps of a current usage scenario;
associating the current usage scenario with the updated screen locking time value; and
when it is detected that a terminal enters the current usage scenario, updating the current screen locking time value into the updated screen locking time value directly.

9. A device for adjusting screen locking time, comprising a time value acquiring module, a determining module and a processing module, wherein
the time value acquiring module is configured to acquire time interval values T1, T2, . . . , and TN between screen locking and screen unlocking for consecutive N times, and send the time interval values T1, T2, . . . , and TN to the determining module, wherein the N value is a preset value;
the determining module is configured to determine whether the time interval values T1, T2, . . . , and TN are all within a preset threshold range and send a determining result to the processing module;
the processing module is configured to receive the determining result, and when the determining result indicates that the time interval values T1, T2, . . . , and TN are all within the preset threshold range, update a current screen locking time value into a sum of the current screen locking time value and a preset time delay value.

10. The device for adjusting screen locking time according to claim 9, wherein the time value acquiring module is further configured to acquire, after each unlocking and before next screen locking, time interval values T21, T22, . . . , and T2N between last time when a user operates initiatively and a current unlocking moment; and
according to the time interval values T21, T22, . . . , and T2N, acquire a first time delay value according to a first preset rule, wherein the preset delay value comprises the first time delay value.

11. The device for adjusting screen locking time according to claim 10, wherein the time value acquiring module is further configured to, after acquiring the time interval values T1, T2, . . . , and TN between screen locking and screen unlocking for consecutive N times, acquire a second time delay value according to a second preset rule according to the time interval values T1, T2, . . . , and TN, wherein the preset time delay value comprises the second time delay value.

12. The device for adjusting screen locking time according to claim 10, wherein the time value acquiring module is further configured to acquire time values T31, T32, . . . , T3N consumed by each unlocking; and according to the time values T31, T32, . . . , T3N, acquire a third time delay value according to a third preset rule, wherein the preset time delay value comprises the third time delay value.

13. The device for adjusting screen locking time according to claim 9, further comprising a monitoring module;
the processing module is configured to update a current default screen locking time value into a sum of a current default screen locking time value and the preset time delay value;
the monitoring module is configured to determine whether a user performs screen locking initiatively after last unlocking or if the user has not operated within a preset operation time threshold; and
if the screen locking is performed initiatively or the user has not operated within the preset operation time threshold, notify the processing module to recover a screen locking time value into the default screen locking time value.

14. The device for adjusting screen locking time according to claim 9, further comprising an associating module;
the processing module is further configured to store an updated screen locking time value;
the associating module is configured to record steps of a current usage scenario, associate the current usage scenario with the updated screen locking time value; and when it is detected that a terminal enters the current usage scenario, notify the processing module to update the current screen locking time value into the updated screen locking time value directly.

15. An electronic terminal, comprising a display screen and further comprising the device for adjusting screen locking time according to claim 9, wherein the device for adjusting screen locking time is connected with the display screen and configured to adjust screen locking time of the electronic terminal.

16. The method for adjusting screen locking time according to claim 2, wherein the preset time delay value comprises a fourth time delay value, and the fourth time delay value is a preset time delay compensation value.

17. The method for adjusting screen locking time according to claim 2, wherein updating the current screen locking time value into the sum of the current screen locking time value and the preset time delay value comprises:
updating a current default screen locking time value into a sum of a current default screen locking time value and the preset time delay value.

18. The method for adjusting screen locking time according to claim 2, further comprising: after updating the current screen locking time value into the sum of the current screen locking time value and the preset time delay value,
storing an updated screen locking time value, and recording steps of a current usage scenario;
associating the current usage scenario with the updated screen locking time value; and
when it is detected that a terminal enters the current usage scenario, updating the current screen locking time value into the updated screen locking time value directly.

19. The device for adjusting screen locking time according to claim 10, further comprising a monitoring module;
the processing module is configured to update a current default screen locking time value into a sum of a current default screen locking time value and the preset time delay value;
the monitoring module is configured to determine whether a user performs screen locking initiatively after last unlocking or if the user has not operated within a preset operation time threshold; and
if the screen locking is performed initiatively or the user has not operated within the preset operation time threshold, notify the processing module to recover a screen locking time value into the default screen locking time value.

20. The device for adjusting screen locking time according to claim 10, further comprising an associating module;
the processing module is further configured to store an updated screen locking time value;
the associating module is configured to record steps of a current usage scenario, associate the current usage scenario with the updated screen locking time value; and when it is detected that a terminal enters the current usage scenario, notify the processing module to update the current screen locking time value into the updated screen locking time value directly.
